(19) United States
(12) Patent Application Publication
(10) Pub. No.: US 2021/0006676 A1
(43) Pub. Date: Jan. 7, 2021

(54) IMAGE FORMING APPARATUS AND IMAGE FORMING METHOD

(71) Applicant: SHARP KABUSHIKI KAISHA, Sakai City (JP)

(72) Inventor: MAKOTO NAKABAYASHI, Sakai City (JP)

(21) Appl. No.: 16/913,151

(22) Filed: Jun. 26, 2020

(30) Foreign Application Priority Data
Jul. 2, 2019 (JP) 2019-123891

(51) Int. Cl. H04N 1/00

(52) U.S. Cl. CPC H04N 1/00458; H04N 1/00456

(57) ABSTRACT

An image forming apparatus includes an image data acquirer, a display, an operation device, a storage, an image forming device, and a controller. When the operation device accepts a command to display the image in one piece of the image data from the list of the acquired image data, the controller causes the display to display a list of the images of all the pages in the one piece of the image data and to store the image of the page selected by the user from the images of all the pages on the list. When the operation device accepts an image formation execution command, the controller causes the image forming device to form an image based on the image data of the selected page related to all the image data stored in the storage.

### BACKGROUND OF THE INVENTION

### Field of the Invention

The present invention relates to an image forming apparatus and an image forming method.

### Description of the Background Art

The following technique has conventionally been known. When receiving data from a fax machine or Internet fax, the multifunction peripheral once saves the received data in memory without printing the data, then displays a list of the received data that is saved in the memory on a preview screen of a display panel so as to allow a user to select the received data, and thereby prints or transfers the received data to a specified address or deletes the received data.

As such an invention, the invention of a fax document transfer device capable of transferring a received fax document to an address by dividing the received fax document into two or more documents or combining the received fax documents (for example, see Japanese Unexamined Patent Application Publication No. 2005-303488).

However, in the conventional method, an editing task such as division or combination can only be performed per document data such as dividing one piece of document data from a designated page or combining two pieces of the document data. Thus, the conventional method is not always convenient for users.

The present invention has been made in view of the circumstance as described so far, and an object thereof is to provide an image forming apparatus and an image forming method capable of editing image data with a higher degree of freedom than the related art when a plurality of pieces of the image data are acquired.

### SUMMARY OF THE INVENTION

1. The present invention provides an image forming apparatus including an image data acquirer that acquires image data including images of one or more pages, a display that displays a list of the images or the image data, an operation device that accepts a command from a user, a storage that stores, out of the image data, an image of the page selected by the user, an image forming device that forms an image on the basis of the image data of the page selected, and a controller that controls the image data acquirer, the display, the operation device, the storage, and the image forming device. In the case where the operation device accepts a command to display the image in one piece of the image data out of the list of the image data acquired, the controller causes the display to display a list of the images of all the pages in the one piece of the image data, and the controller causes the storage to store , out of the images of all the pages on the list, an image of the page that is selected by the user. In the case where the operation device accepts an image formation execution command, the controller causes the image forming device to form an image on the basis of the image data of a selected page that is related to all the image data stored in the storage.

In addition, the present invention provides an image forming method including acquiring image data including images of one or more pages, displaying a list of the image data, operating to accept a command to display an image in one piece of the image data out of the list of the image data, displaying a list of the images of all the pages in the one piece of the image data, storing, out of the images of all the pages on the list, an image of the page that is selected by a user, and forming an image on the basis of the image data of the selected page that is related to all the image data stored in the storing.

In the present invention, the “image data acquirer” is a portion that receives the image data via a network, an analog line (such as fax), a universal serial bus (USB) stick, or the like, for example.

Alternatively, the “image data acquirer” may generate and acquire the image data in a specified file format (a joint photographic experts group (JPEG), portable network graphics (PNG), a portable document format (PDF), or the like) by reading a document with an image reading function of a scanner or the like.

The “image forming apparatus” is an apparatus such as a multifunction peripheral having a scanner function, electronic mail/fax transmitting and receiving functions, and a printing function, and the “image forming apparatus” has an image data receiving function to receive the image data, image data transmitting and receiving functions to transmit and receive an electronic mail or a faxed material to external equipment, and an image forming function to form and output the image on the basis of the image data.

The “image data acquirer” in the present invention is implemented by the image acquirer 11.

According to the present invention, when a plurality of pieces of the image data are acquired, the image of the page that is freely selected from the plurality of pieces of the image data is stored and processed. Therefore, the image forming apparatus that is more convenient for the user than the related art can be implemented.

Furthermore, a description will be made on preferred aspects of the present invention.

2. The controller may cause the display to display a list of the image of the selected page that is related to all the image data stored in the storage.

In this way, when the plurality of pieces of the image data are acquired, the image of the page that is freely selected from the plurality of pieces of the image data is displayed on the list. Therefore, the image forming apparatus that is more convenient for the user than the related art can be implemented.

3. In the case where the controller causes the display to display the list of the image of the selected page that is related to all the image data stored in the storage, the controller may also cause the display to display reference information indicating a relationship with the image of the original acquired image data for each image of the selected page.

The “reference information” is information on, of the acquired original image data, the page and the image data from which the selected image is selected.

In this way, it is possible to easily check, of the original image data, the page and the image data from which the image of the selected page is selected. Therefore, the image forming apparatus that is more convenient for the user than the related art can be implemented.

4. In the case where the operation device accepts a command to select one piece of the image data from the list of the image data, the controller may store the images of all the pages in the one piece of the image data in the storage with an assumption that the images of all the pages in the one piece of the image data are selected.

In this way, when the plurality of pieces of the image data are acquired, the images of all the pages in the image data are collectively selected by simply selecting the specified image data from the plurality of pieces of the image data. Therefore, the image forming apparatus that is more convenient for the user than the related art can be implemented.

### BRIEF DESCRIPTION OF THE DRAWINGS

FIG. 1 is a perspective view of external appearance of a digital multifunction peripheral according to a first embodiment of the present invention.

FIG. 2 is a block diagram of a schematic configuration of the digital multifunction peripheral illustrated in FIG. 1.

FIG. 3 is a flowchart of an exemplary procedure of image data editing processing by the digital multifunction peripheral illustrated in FIG. 1.

FIG. 4 is a flowchart of an exemplary procedure of selection processing of acquired image data by the digital multifunction peripheral illustrated in FIG. 3.

FIG. 5 is a flowchart of an exemplary procedure of processing of an execution job by the digital multifunction illustrated in FIG. 3.

FIGS. 6A to 6E include explanatory views of a specific example of the image data editing processing by the digital multifunction peripheral illustrated in FIG. 1.

FIGS. 7A and 7B include explanatory views of a specific example of image data editing processing by a digital multifunction peripheral according to a second embodiment of the present invention.

FIGS. 8A to 8C include explanatory views of a specific example of image data editing processing by a digital multifunction peripheral according to a third embodiment of the present invention.

FIGS. 9A to 9C include explanatory views of a specific example of image data editing processing by a digital multifunction peripheral according to a fourth embodiment of the present invention.

FIGS. 10A to 10C include explanatory views of a specific example of image data editing processing by a digital multifunction peripheral according to a fifth embodiment of the present invention.

### DESCRIPTION OF THE PREFERRED EMBODIMENTS

A detailed description will hereinafter be made on the present invention with reference to the drawings.

The following description is illustrative in all respects and thus is not construed as limiting the present invention.

### First Embodiment

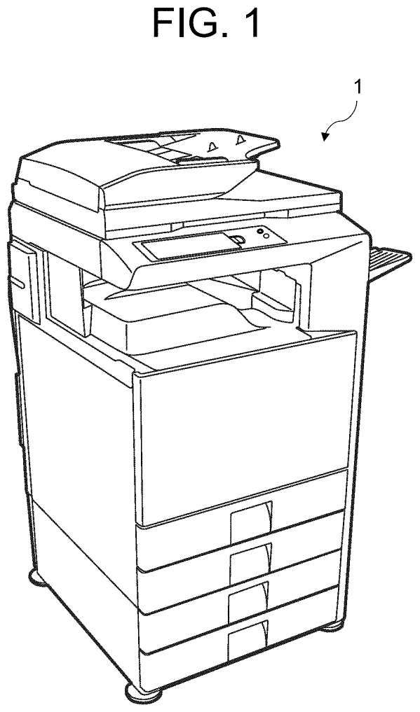

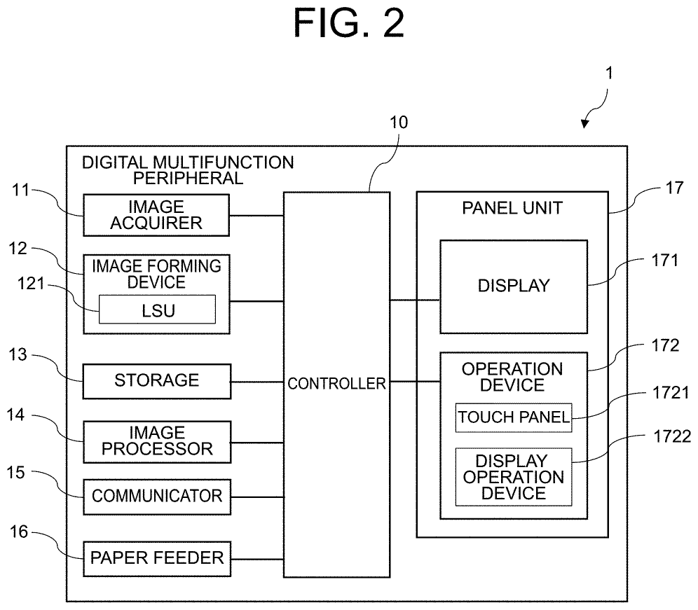

A description will be made on a digital multifunction peripheral 1 as an embodiment of the image forming apparatus according to the present invention with reference to FIG. 1 and FIG. 2.

FIG. 1 is a perspective view of external appearance of the digital multifunction peripheral 1 according to a first embodiment of the present invention. FIG. 2 is a block diagram of a schematic configuration of the digital multifunction peripheral 1 illustrated in FIG. 1.

The present invention is not limited to the digital multifunction peripheral 1 and can be applied to all types of equipment that have an image data acquiring (receiving) function and an image data transmitting function such as a scanner, a fax machine, and an electronic mail.

The digital multifunction peripheral 1 is an apparatus such as a multifunction peripheral (MFP) that executes digital processing of image data and has a copier function, a scanner function, and a facsimile function.

The digital multifunction peripheral 1 executes a job such as scanning, printing, copying, or image transmission (Scan to Email or Scan to a file transfer protocol (Ftp)) on the basis of an instruction from a user that is accepted via an operation device 172 or a communicator 15.

As illustrated in FIG. 2, the digital multifunction peripheral 1 includes a controller 10, an image acquirer 11, an image forming device 12, a storage 13, an image processor 14, the communicator 15, a paper feeder 16, and a panel unit 17.

A description will hereinafter be made on each component of the digital multifunction peripheral 1.

The controller 10 integrally controls the digital multifunction peripheral 1 and includes a central processing unit (CPU), a random-access memory (RAM), a read-only memory (ROM), various interface circuits, and the like.

In order to control entire operation of the digital multifunction peripheral 1, the controller 10 monitors and controls various loads such as detection of each sensor, a motor, a clutch, and the panel unit 17.

The image acquirer 11 is a portion that detects and reads a document placed on a document table or a document conveyed from a document tray to generate the image data. The image acquirer 11 is also a portion that acquires the image data generated by an external information processor (not illustrated), a facsimile machine (not illustrated), or the like.

When acquiring the image data from the external information processor or the like, the image acquirer 11 may acquire the image data via a wired or wireless network, may acquire the image data through an analog line, may acquire the image data that is recorded in a USB stick or the like, or may have a function that combines these.

The image forming device 12 is a portion that prints out the image data generated by the image processor 14 on a sheet and includes a laser scanning unit (LSU) 121.

The LSU 121 is a device that irradiates a surface of a charged photoconductor drum with a laser beam that corresponds to image information including a digital signal acquired by the image acquirer 11, so as to form an electrostatic latent image.

The storage 13 is an element or a storage medium that stores information required to implement the various functions of the digital multifunction peripheral 1, a control program, and the like. For example, the storage medium such as a semiconductor element, examples of which are the RAM and the ROM, a hard disk, a flash storage, or a solid state drive (SSD) is used.

The program and the data may be kept in different devices such that an area for keeping the data is a hard disk drive and an area for keeping the program is the flash storage.

The image processor 14 is a portion that converts a document image read by the image acquirer 11 into an appropriate electrical signal so as to generate the image data and that executes processing such as enlarging or shrinking on the image data received from the image acquirer 11 according to a command from the operation device 172 so as to make the image data suited for output.

The image processor 14 also processes the image data of arbitrary plurality of pages selected by the user and then executes processing to generate the image data in a file format such as portable document format (PDF) or tagged image file format (TIFF).

The communicator 15 is a portion that communicates with a computer, a portable information terminal, the external information processor, the facsimile machine or the like via the network and exchanges various types of information such as the electronic mail and the fax with any of these external communication devices.

The paper feeder 16 is a portion that conveys the sheet stored in a paper feeding cassette or a manual feed tray to the image forming device 12.

The panel unit 17 includes a display 171 and the operation device 172.

The display 171 is a portion that displays the various information. For example, the display 171 is a display that is constructed of a cathode-ray tube (CRT) display, a liquid crystal display, an electroluminescent (EL) display, or the like and that is a monitor, a line display, or the like used by an operating system or application software to display electronic data such as a processing state. The controller 10 displays the operation and a state of the digital multifunction peripheral 1 on the display 171.

The operation device 172 is a portion that includes a touch panel 1721 and a display operation device 1722 and that accepts a command from the user.

### Image Data Editing Processing by Digital Multifunction Peripheral 1

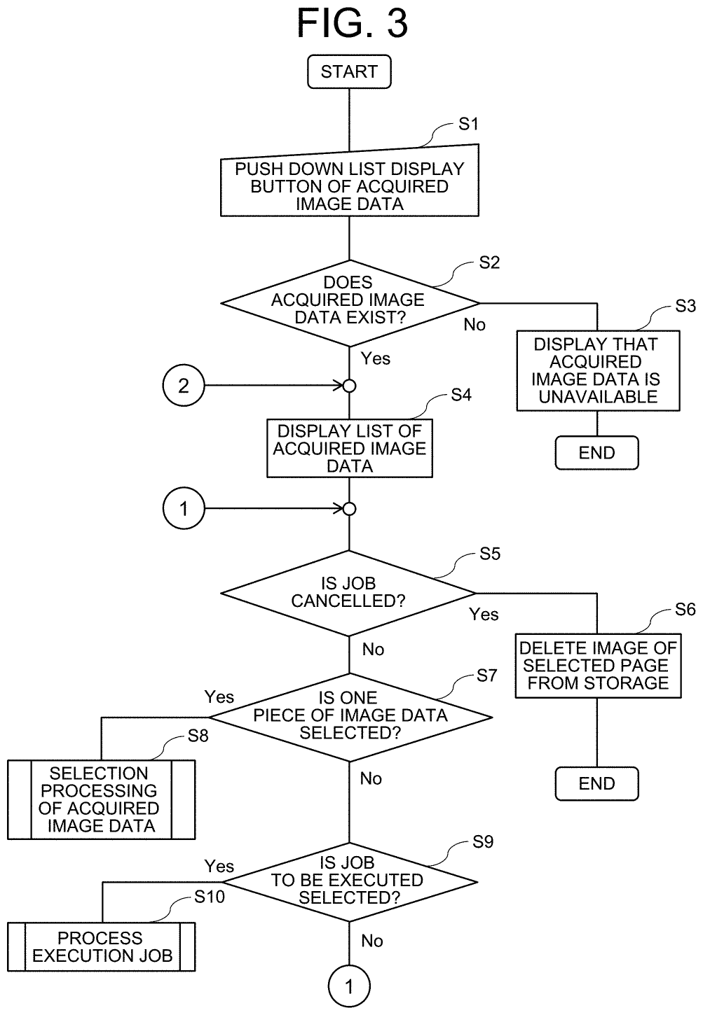

Next, a description will be made on image data editing processing by the digital multifunction peripheral 1 according to the first embodiment of the present invention with reference to FIG. 3 to FIGS. 6A to 6E.

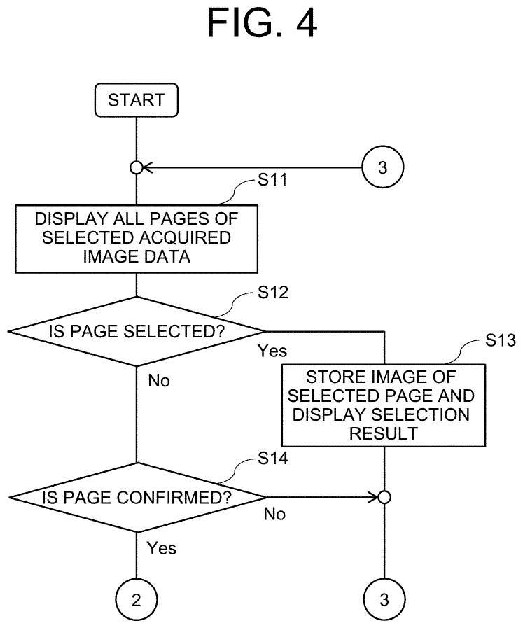

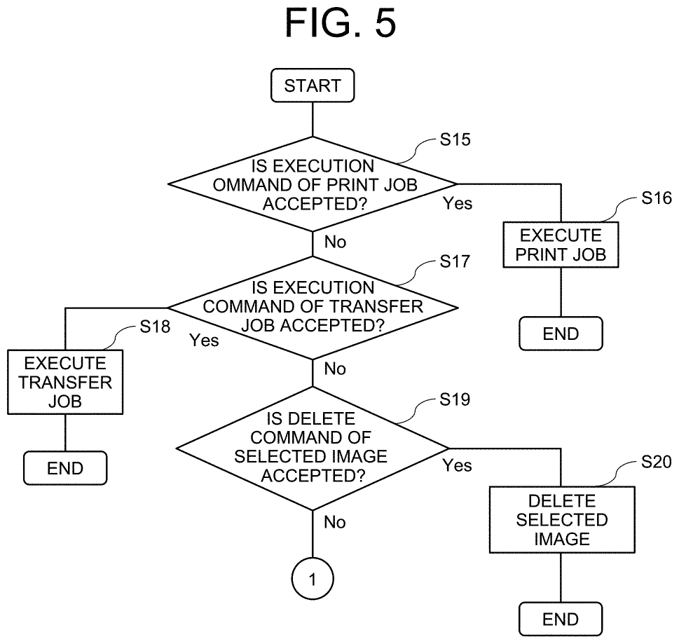

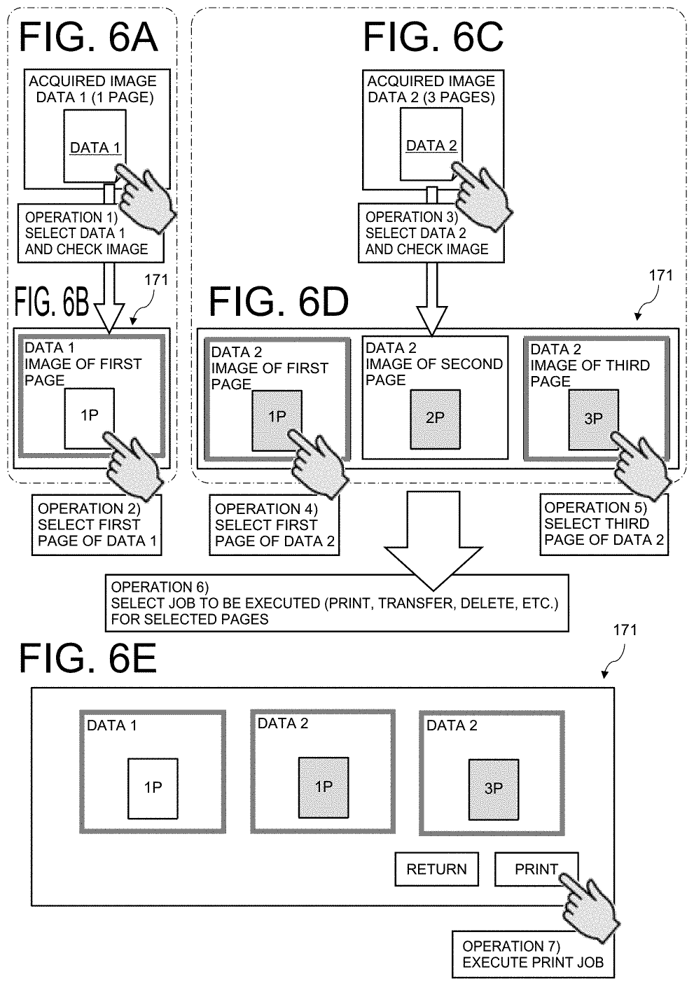

FIG. 3 is a flowchart of an exemplary procedure of the image data editing processing by the digital multifunction peripheral 1 illustrated in FIG. 1. FIG. 4 is a flowchart of an exemplary procedure of selection processing of acquired image data by the digital multifunction peripheral 1 illustrated in FIG. 3. FIG. 5 is a flowchart of an exemplary procedure of processing of an execution job by the digital multifunction peripheral 1 illustrated in FIG. 3. FIGS. 6A to 6E include explanatory views of a specific example of the image data editing processing by the digital multifunction peripheral 1 illustrated in FIG. 1.

In step S1 illustrated in FIG. 3, in the case where the user pushes down a list display button of predetermined acquired image data (step S1), in step S2, the controller 10 determines whether the image data acquired by the image acquirer 11 (hereinafter, acquired image data) exists (step S2).

If the acquired image data does not exist (if No in the determination in step S2), in step S3, the controller 10 causes the display 171 to display that the acquired image data is unavailable (step S3), and terminates the processing.

On the other hand, if the acquired image data exists (if Yes in the determination in step S2), in step S4, the controller 10 displays a list of the acquired image data (step S4).

Next, in step S5, the controller 10 determines whether the job is canceled (step S5).

If the job is canceled (if Yes in the determination in step S5), in step S6, the controller 10 deletes an image of a selected page from the storage 13 (step S6), and terminates the processing.

On the other hand, if the job is not canceled (if No in the determination in step S5), in step S7, the controller 10 determines whether one piece of the acquired image data is selected (step S7).

If the one piece of the acquired image data is selected (if Yes in the determination in step S7), in step S8, the controller 10 executes selection processing of the acquired image data (step S8).

Details of the selection processing of the acquired image data will be described in a description on FIG. 4.

On the other hand, if the one piece of the acquired image data is not selected (if No in the determination in step S7), in step S9, the controller 10 determines whether the job to be executed is selected (step S9).

If the job to be executed is selected (if Yes in the determination in step S9), in step S10, the controller 10 processes the execution job (step S10).

Details of processing of the execution job will be described in a description on FIG. 5.

On the other hand, if the job to be executed is not selected (if No in the determination in step S9), the processing is returned to the determination in step S5 by the controller 10 (step S5).

### Selection Processing of Acquired Image Data

Next, a description will be made on the selection processing of the acquired image data with reference to FIG. 4.

In step S11 illustrated in FIG. 4, the controller 10 displays all pages of the selected acquired image data (step S11).

Next, in step S12, the controller 10 determines whether a particular page is selected from all the pages of the selected acquired image data (step S12).

If the particular page is selected (if Yes in the determination in step S12), in step S13, the controller 10 stores an image of the selected page in the storage 13 and causes the display 171 to display a selection result (step S13).

Thereafter, the processing is returned to step S11 by the controller 10 (step S11).

Examples of a method for displaying the selection result are a method by enclosing the selected image with a thick frame and a method by changing a color of the selected image.

On the other hand, if the page is not selected (if No in the determination in step S12), in step S14, the controller 10 determines whether the selected page is confirmed (step S14).

More specifically, the controller 10 determines that the selected page is confirmed when the display 171 displays a “confirmation” button and the “confirmation” button is pressed.

If the selected page is confirmed (if Yes in the determination in step S14), the processing is returned to step S4 in FIG. 3 by the controller 10 (step S4 in FIG. 3).

On the other hand, if the selected page is not confirmed (if No in the determination in step S14), the processing is returned to step S11 by the controller 10 (step S11).

More specifically, when the display 171 displays a “RETURN” button and the “RETURN” button is pressed, the controller 10 determines that the page is not confirmed, and the display 171 displays the last screen.

### Processing of Execution Job

Next, a description will be made on the processing of the execution job with reference to FIG. 5.

In step S15 illustrated in FIG. 5, the controller 10 determines whether the operation device 172 accepts a command of a print job (step S15).

If the operation device 172 accepts the execution command of the print job (if Yes in the determination in step S15), in step S16, the controller 10 causes the image forming device 12 to execute the print job (step S16), and terminates the processing.

On the other hand, if the operation device 172 does not accept the execution command of the print job (if No in the determination in step S15), in step S17, the controller 10 determines whether the operation device 172 accepts the execution command of a transfer job (step S17).

If the operation device 172 accepts the execution command of the transfer job (if Yes in the determination in step S17), in step S18, the controller 10 causes the communicator 15 to execute the transfer job (step S18), and terminates the processing.

On the other hand, if the operation device 172 does not accept the execution command of the transfer job (if No in the determination in step S17), in step S19, the controller 10 determines whether the operation device 172 accepts a delete command of the selected image (step S19).

If the operation device 172 accepts the delete command of the selected image (if Yes in the determination in step S19), in step S20, the controller 10 deletes the selected image (step S20), and terminates the processing.

On the other hand, if the operation device 172 does not accept the delete command of the selected image (if No in the determination in step S19), the processing is returned to step S5 in FIG. 3 by the controller 10 (step S5 in FIG. 3).

### Specific Example of Editing Processing of Acquired Image Data

Next, a description will be made on a specific example of editing processing of the acquired image data with reference to FIGS. 6A to 6E.

In an example illustrated in FIGS. 6A to 6E, such a case is assumed that the digital multifunction peripheral 1 acquires one page of the acquired image data (DATA 1) and three pages of the acquired image data (DATA 2).

At this time, the display 171 displays a list of icons such as “DATA 1” and “DATA 2” or the like.

Here, as illustrated in FIG. 6A, when the user selects the icon of “DATA 1” (OPERATION 1), as illustrated in FIG. 6B, the display 171 displays an image of a first page of DATA 1.

Next, when the user selects the image of the first page, the area around the selected image is displayed with the thick frame, which indicates that the image is in a selected state (OPERATION 2).

Meanwhile, as illustrated in FIG. 6C, when the user selects the icon of “DATA 2” (OPERATION 3), as illustrated in FIG. 6D, the display 171 displays images of the first page to the third page of DATA 2.

If the number of the pages is large in FIG. 6D, pages of the images may be scrolled horizontally or vertically according to movement of a finger.

Next, when the user selects the images of the first page and the third page, areas around the selected images are displayed with the thick frames, which indicates that the images are in the selected state (OPERATION 4 and OPERATION 5).

Next, when the job to be executed (print, transfer, delete, or the like) for the selected pages is selected (OPERATION 6), as illustrated in FIG. 6E, the display 171 displays a list of the images of the selected pages of DATA 1 and DATA 2 (the first page of DATA 1 and the first and third pages of DATA 2).

In FIG. 6E, when the user presses a “PRINT” button (OPERATION 7), the job is executed for the image data of the selected pages.

As described above, when the plurality of pieces of the image data are acquired, the job for the images of the pages that are freely selected from the plurality of pieces of the image data is executed as the single job. As a result, the digital multifunction peripheral 1 that is more convenient for the user than the related art is implemented.

### Second Embodiment

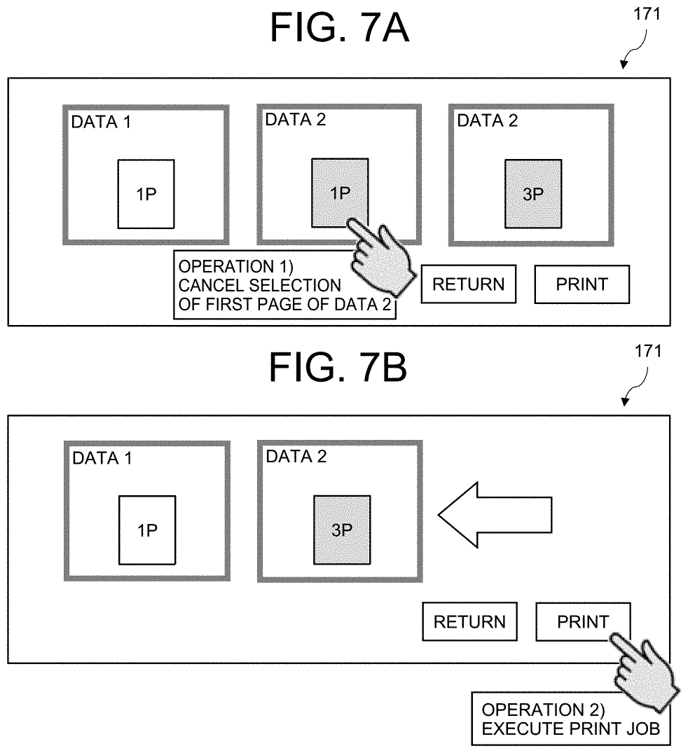

Next, a description will be made on image data editing processing by a digital multifunction peripheral 1 according to a second embodiment of the present invention with reference to FIGS. 7A and 7B.

FIGS. 7A and 7B include explanatory views of a specific example of the image data editing processing by the digital multifunction peripheral 1 according to the second embodiment of the present invention.

As illustrated in FIG. 7A, when the display 171 displays the list of the first page of DATA 1 and the first page and the third page of DATA 2, the user cancels the selection of the image of the first page of DATA 2 (OPERATION 1).

At this time, the image of the first page of DATA 2 is deleted from the display 171, and the display 171 displays a list of the images of the remaining pages (the first page of DATA 1 and the third page of DATA 2).

In FIG. 7B, when the user presses the “PRINT” button (OPERATION 2), the job for the images of the remaining pages is executed as the single job.

As described above, simply by canceling the selection of one or some of the listed pages, the job for the images of the remaining pages is executed as the single job. As a result, the digital multifunction peripheral 1 that is more convenient for the user than the related art is implemented.

### Third Embodiment

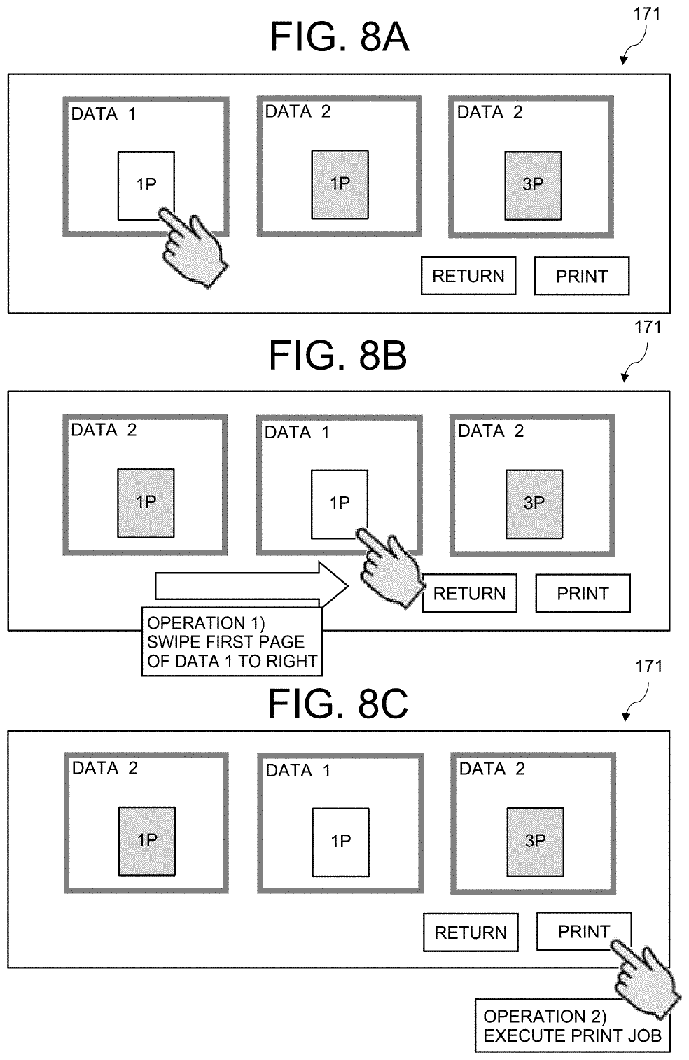

Next, a description will be made on image data editing processing by a digital multifunction peripheral 1 according to a third embodiment of the present invention with reference to FIGS. 8A to 8C.

FIGS. 8A to 8C include explanatory views of a specific example of the image data editing processing by the digital multifunction peripheral 1 according to the third embodiment of the present invention.

As illustrated in FIG. 8A, when the display 171 displays the list of the first page of DATA 1 and the first page and the third page of DATA 2, the user slides (swipes) the image of the first page of DATA 1 to the right while pressing such an image, so as to move the first page of DATA 1 between the first page of DATA 2 and the third page of DATA 2 (OPERATION 1).

At this time, as illustrated in FIG. 8B, the display 171 displays that the image of the first page of DATA 1 and the image of the first page of DATA 2 are switched.

Thereafter, in FIG. 8C, when the user presses the “PRINT” button (OPERATION 2), the images of the selected pages are stored while the pages remain being switched, and the job for the images is executed as the single job.

As described above, by swiping and switching the desired page of the listed pages with another page, an order of the pages that are selected from the plurality of pieces of the image data is easily changed, and the job for the pages is executed as the single job. As a result, the digital multifunction peripheral 1 that is more convenient for the user than the related art is implemented.

### Fourth Embodiment

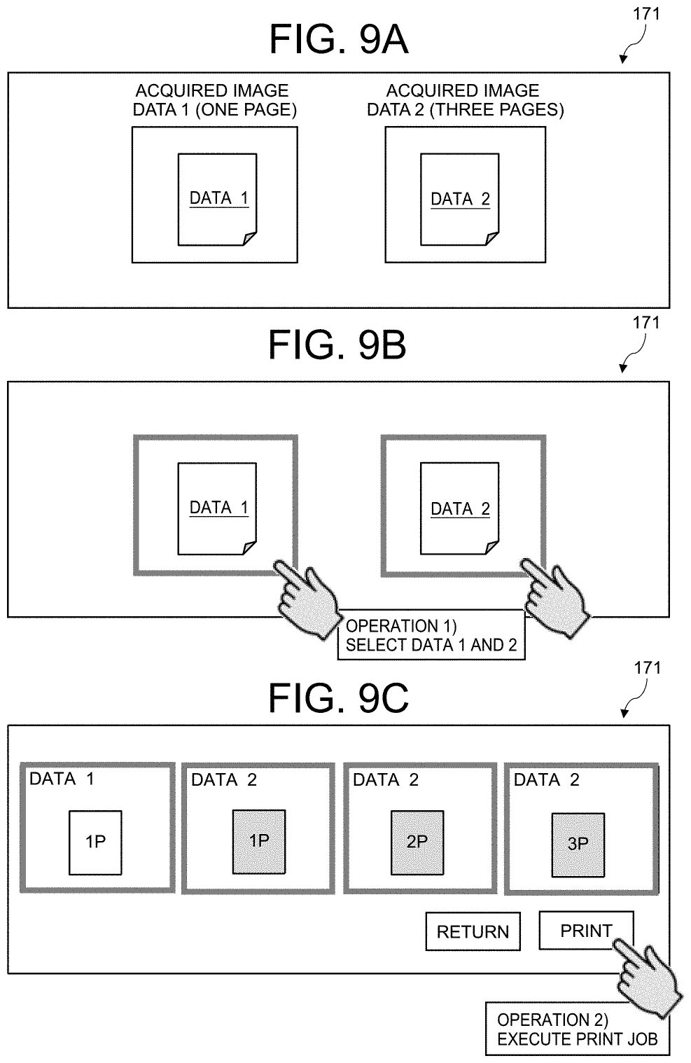

Next, a description will be made on image data editing processing by a digital multifunction peripheral 1 according to a fourth embodiment of the present invention with reference to FIGS. 9A to 9C.

FIGS. 9A to 9C include explanatory views of a specific example of the image data editing processing by the digital multifunction peripheral 1 according to the fourth embodiment of the present invention.

As illustrated in FIG. 9A, such a case is assumed that the digital multifunction peripheral 1 acquires the one page of the acquired image data (DATA 1) and the three pages of the acquired image data (DATA 2).

At this time, as illustrated in FIG. 9B, when DATA 1 and DATA 2 are selected (OPERATION 1), all the pages in DATA 1 and DATA 2 are brought into the selected state.

Here, when one piece of the image data is clicked among the plurality of pieces of the listed image data, such image data may be selected. In addition, when the one piece of the image data is double-clicked, the images of all the pages in such image data may be listed.

Next, when the job to be executed (print, transfer, delete, or the like) is selected, as illustrated in FIG. 9C, the display 171 displays a page of a list in which the images of all the pages of DATA 1 and DATA 2 are selected.

Thereafter, in FIG. 9C, when the user presses the “PRINT” button (OPERATION 2), the images of the selected pages are stored, and the job for the images is executed as the single job.

As described above, by selecting the desired image data from the list of the acquired image data, the images of all the pages in the image data are brought into the selected state. As a result, the digital multifunction peripheral 1 that is more convenient for the user than the related art is implemented.

### Fifth Embodiment

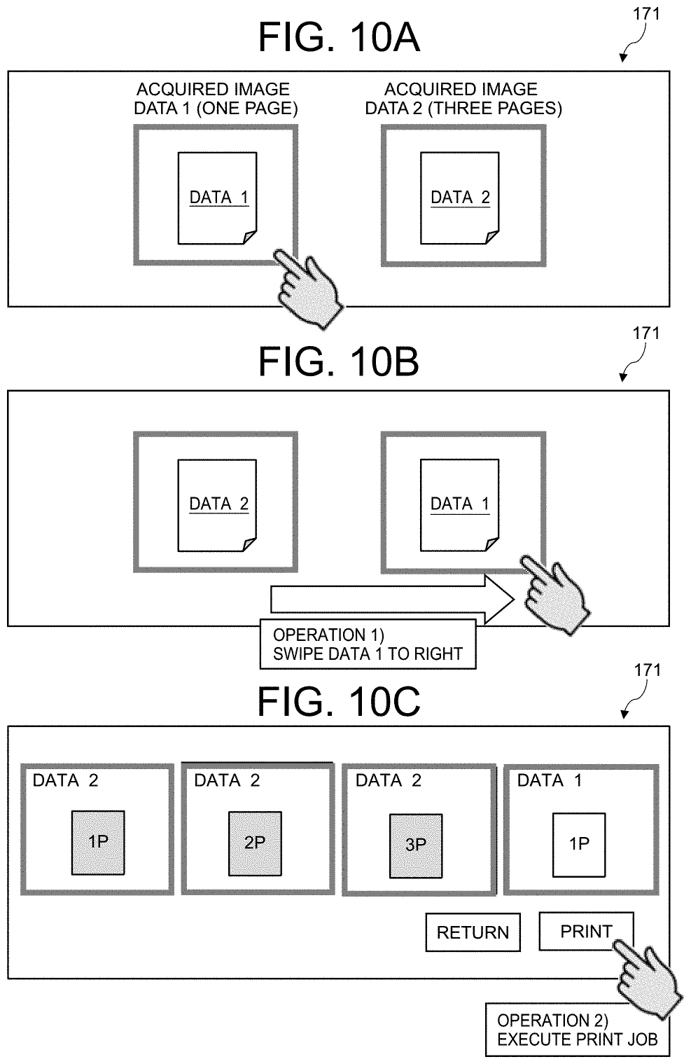

Next, a description will be made on image data editing processing by a digital multifunction peripheral 1 according to a fifth embodiment of the present invention with reference to FIGS. 10A to 10C.

FIGS. 10A to 10C include explanatory views of a specific example of the image data editing processing by the digital multifunction peripheral 1 according to the fifth embodiment of the present invention.

As illustrated in FIG. 10A, such a case is assumed that the one of the acquired image data (DATA 1) and the three pages of the acquired image data (DATA 2) are in the selected state.

At this time, as illustrated in FIG. 10B, when the user slides (swipes) the image of DATA 1 to the right while pressing such an image (OPERATION 1), the display 171 displays that DATA 1 and DATA 2 are switched.

Next, when the job to be executed (print, transfer, delete, or the like) is selected, as illustrated in FIG. 10C, the display 171 displays the list of the images of all the pages of DATA 2 and DATA 1.

Here, by reflecting the positions of the image data in FIG. 10B, the images of all the pages of DATA 2 are displayed on a left side while the image of the page of DATA 1 is displayed on the right side.

Thereafter, in FIG. 10C, when the user presses the “PRINT” button (OPERATION 2), the images of the selected pages are stored while the pages of DATA 1 and DATA 2 remain being switched, and the job for the images is executed as the single job.

As described above, by swiping and switching the desired image data of the listed image data with another image data, the order of the pages is easily changed per the image data, and the job for the pages is executed as the single job. As a result, the digital multifunction peripheral 1 that is more convenient for the user than the related art is implemented.

Combinations of any of the above-described plurality of embodiments are also included in the preferred embodiments of the present invention. In addition to the above-described embodiments, various modified examples can be made to the present invention. Those modified examples is not construed as not belonging to the scope of the present invention. The present invention includes all modifications that fall within the scope and equivalent meaning of the claims.

### DESCRIPTION OF REFERENCE NUMERALS

1: Digital multifunction peripheral

10: Controller

11: Image acquirer

12: Image forming device

13: Storage

14: Image processor

15: Communicator

16: Paper feeder

17: Panel unit

121: Laser scanning unit (LSU)

171: Display

172: Operation device

1721: Touch panel

1722: Display operation device

What is claimed is:

1. An image forming apparatus comprising:
an image data acquirer that acquires image data including images of one or more pages;
a display that displays a list of the images or the image data;
an operation device that accepts a command from a user;
a storage that stores, out of the image data,animage of a page selected by the user;
an image forming device that forms an image on a basis of image data of the page selected; and
a controller that controls the image data acquirer, the display, the operation device, the storage, and the image forming device,
wherein,if the operation device accepts a command to display animage in one piece of image data out ofthe list of the image data acquired, the controller causes the display to display a list of images of all pages in the one piece of image data andcauses the storage to store, out of the images of all the pages on the list,animage of apage that is selected by the user, and
wherein, if the operation device accepts an image formation execution command, the controller causes the image forming device to form an image on the basis of image data of a selected page that is related to all image data stored in the storage.

2. The image forming apparatus according to claim 1, whereinthe controller causes the display to display a list of images of selected pages that arerelated to all the image data stored in the storage.

3. The image forming apparatus according to claim 2, wherein, when causing the display to display the list of the images of the selected pages that arerelated to all the image data stored in the storage, the controller causes the display to additionally display, for each of the images of the selected pages,reference information indicating a relationship with animage of image data that is acquired as original.

4. The image forming apparatus according to claim 1, wherein, if the operation device accepts a command to select one piece of image data from the list of the image data, the controller causes the storage to store images of all pages in the one piece of image data onan assumption that the images of all the pages in the one piece of image data are selected.

5. An image forming method comprising:
acquiring image data including images of one or more pages;
displaying a list of the image data;
accepting a command to display an image in one piece of image data out ofthe list of the image data;
displaying a list of images of all pages in the one piece of image data;
storing,out of the images of all the pages on the list,animage of apage that is selected by a user; and
forming an image on abasis of image data of a selectedpage that is related to all image data storedin the storing.
